(19) United States
(12) Patent Application Publication
(10) Pub. No.: US 2008/0156126 A1
(43) Pub. Date: Jul. 3, 2008

(54) SkyKraft: gyroscopic torque unidirectional engine

(76) Inventors: Robert Monte Prichard, Mesquite, TX (US); Robert Kraft McClelland, Mesquite, TX (US)

Correspondence Address: ROBERT K. MCCLELLAND AND;ROBERT M. PRICHARD, 1822 CEDARBROOK DRIVE, MESQUITE, TX, 75181, US

(21) Appl. No.: 11/071,100

(22) Filed: Jul. 11, 2005

(51) Int. Cl. G01C 19/00

(52) U.S. Cl. 74/5.34; 74/5 R; 74/5.4

(57) ABSTRACT

Gyroscopic Torque Induced Unidirectional Engine is a combination of five engines with a center bi-directional torque motor controlling torque speed, direction and timing of both upper and lower pair-sets of Gyro engines attached to center motors upper and lower drive axles. By electronically manipulating the power to the bi-directional torque motor and the gyros', the force factors are controlled between the upper and lower sets. With the first phase of upper gyros operations repeated by the second phase of lower gyros inducing torques speeds and directions 180 degrees out of phase with the upper gyros. Timing is synchronized for gyros to support one another through its push-reach, pull-reach, “crawl” through space like a twisting caterpillar to obtain an overall combined total engine thrust in a single direction overcoming accelerated Gravity's weight plus POWER to create engine speed in any of the controlled directions.

### I. SYSTEM OPERATIONS

### Disclosure of Technical

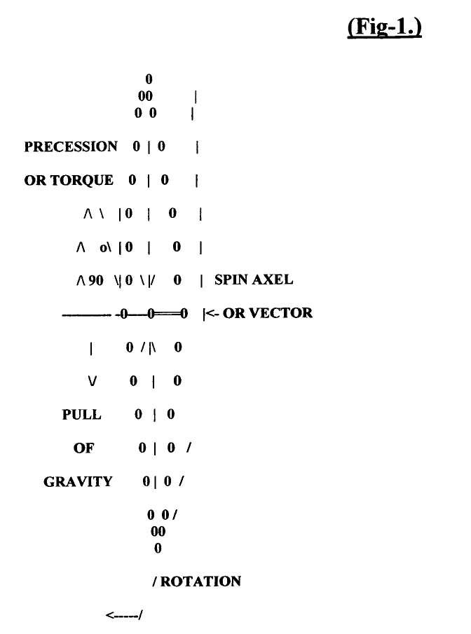

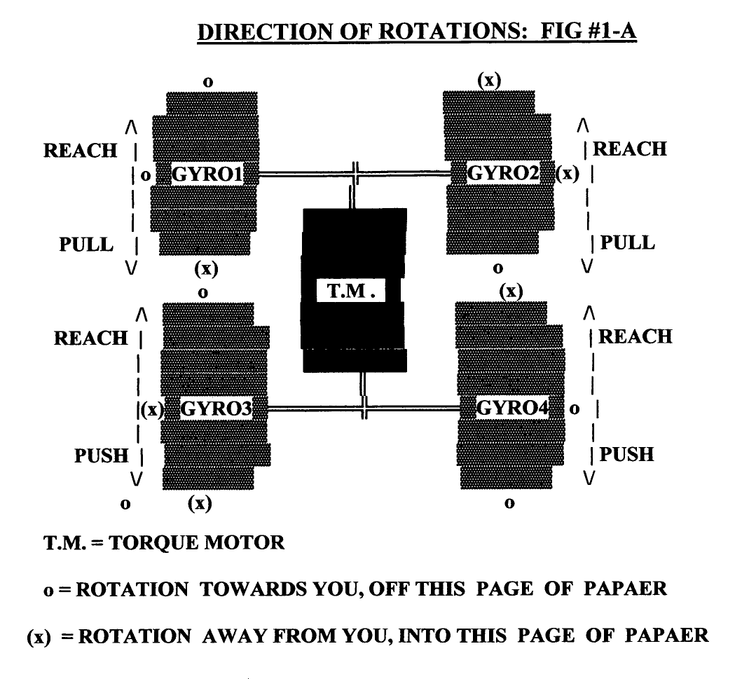

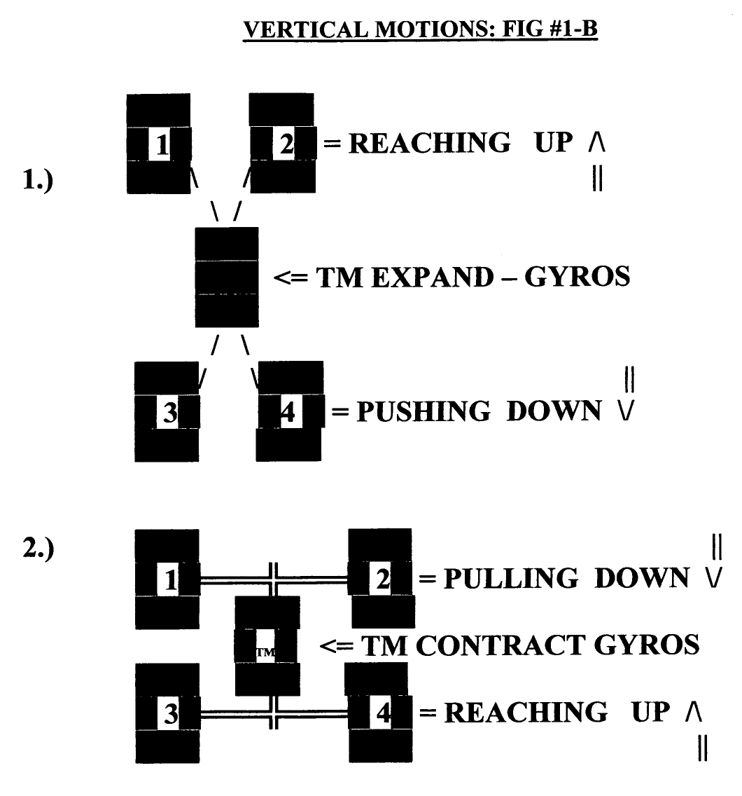

In the following pages are the description, schematics, specifications, blue-prints and operating directions for the Biblical prophesized chariot of the Gods, titled “Sky-Kraft”, for the “Gyroscopic Torque Induced Unidirectional Engine.” This engine will internally force itself in any direction it is controlled regardless of the surrounding environment or atmosphere, whether it be gas, liquid or solid. The second coming of the gyroscope as a rebuilt mechanism by the researchers at the Naval Research Laboratory may have lighter avionic navigation answers. An ordinary gyro consists of a spinning wheel on an axis, resisting any force upon its spinning rotational plane. The heavier the wheel and the faster the rotational spin, the harder the gyro insists to maintain its three dimensional position. Imagine holding a fast spinning bicycle wheel by the axle in a vertical position above the ground. (See FIG. 1)

As gravity pulls down the suspended end of the axle, the wheel will turn in a ninety degree precision to the right. Almost as riding a bicycle, remember how one was able to learn to balance on wheels? That was easy; next one had to learn how to turn. The best method was to lean over in The direction one wanted to turn and the front wheel followed. The next trick was after the turn to counter balance before falling to the ground again. Work is equal to force times distance (W=F*D).

### II. PROTOTYPE

For gyros, consider two special types of acceleration. The first is a force on a moving body directed along the same direction as its velocity; the body will speed up or slow down, its direction of travel remaining unchanged. The second is the situation when the force is always at right angles to the velocity vector. Then the direction of the velocity will be continuously changing, but its magnitude will remain constant. If gyroscopes will maintain a set plane in space, and only alter from that space at a ninety degree angle, with an angular motion in relation to the induced pressure, then any arrangement of that physical formula is possible.” (CLAIM-#1) “I Claim” that this engine will internally force itself in any direction it is controlled regardless of the surrounding environment or atmosphere, whether it be gas, liquid or solid. (CLAIM-#2) “I claim that” an induced torque applied at a patented secret location in relation to another torque upon or within a gyroscope or related mechanism can produce that primary force or pressure in the opposite direction. If this change of location is what a gyro measures, “I claim (CLAIM-#3) that” when a Gyroscopic Torque Induced Uni-directional Engine can use electricity to change location. Similar to gyros' change of location to produce electricity for mechanical measurements, “I claim (CLAIM-#4) that” the power applied can be controlled, so control directions can maneuver the engine in directions systematically controlled to create it's motion: If “work is equal to its mass times its distance”, “I claim (CLAIM-#6) that” its acceleration times that” the distance displacement accomplished through vector angle reinforced torque inductions by the “actions” of Gyros. This phase of operations is repeated by the second similar arrangement of gyros inducing torques 180 degrees out of phase, but “I claim (CLAIM-#7) that” timed to support one another through its counter reaction, “I claim that” it can “crawl” through space like a twisting caterpillar. The Sky Kraft engine cycle climbing through space “I claim (CLAIM-#8) that” is similar to the four cycle piston engine with: intake, power, compression and exhaust, only redefined as: push-reach, pull-reach acts as these Gyros create induced propulsions.

### Abstract Design Specifications

### For Individual Page-Format of the Above See FIG. 1

First begin with power off and gravity in full force acting on the entire engine at the engine weight, 32 ft./per sec squared times total engine mass.

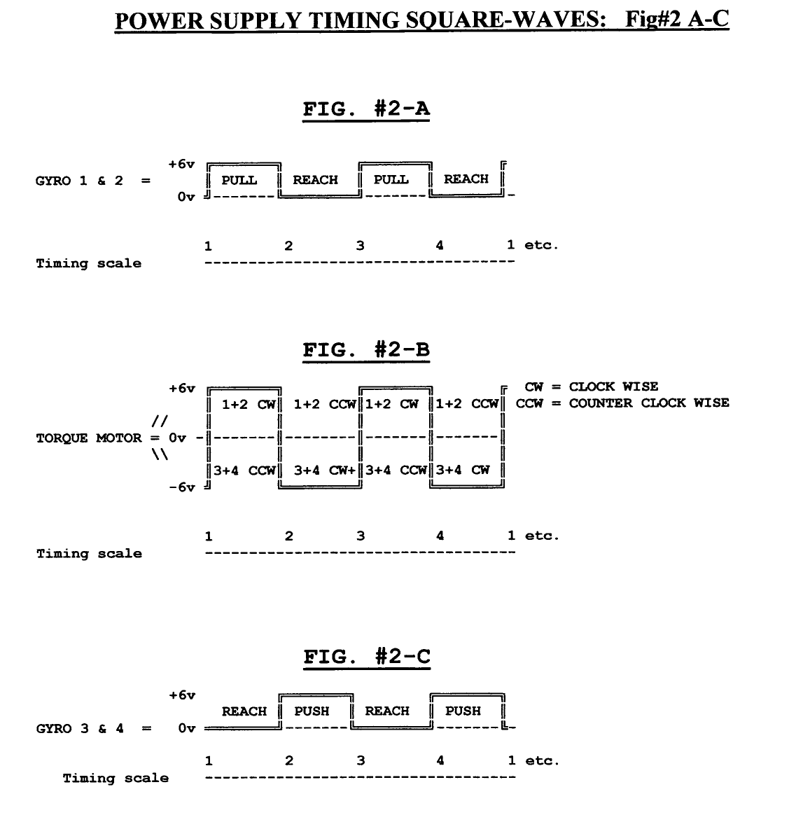

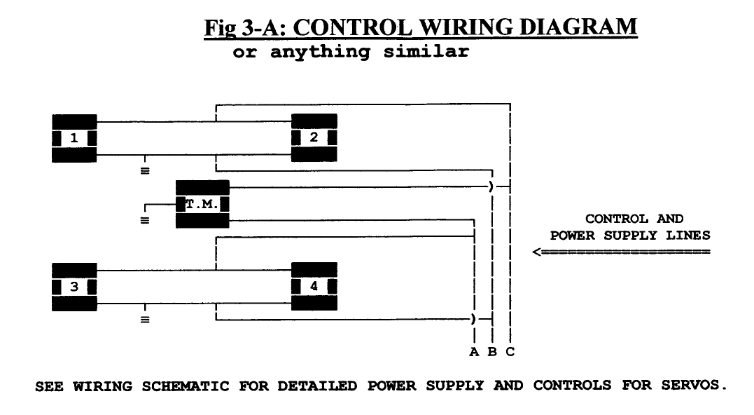

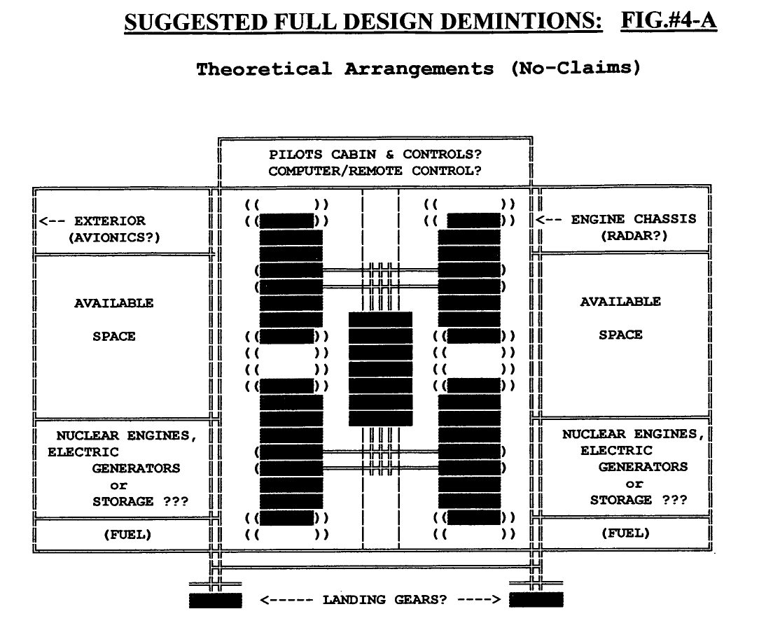

After gyros 1 through 4 are supplied beginning spin voltages. Gyros 1 & 2 FIG. 2-A are supplied with +6V square wave in parallel with +6 v clockwise Contracting torque motor power will cause antigravity “PULL” power as displayed in FIG. 1-B.2. This first time period or span is complimented by reverse spin torque applied to gyros 3 & 4 with 0 v, allowing them to “REACH” without generating counter spin torque against gyros 1 & 2 with “No Loss” as 0-volt of inducing voltage for gyros 3 & 4 rotation may allow it to lose Spin RPM as balance of energy, as it climbs in a reaching motion. This same occurs in reverse as Gyros 3&4 exhort “PUSH” Power Against Gravity power as displayed in FIG. 1-B.1 This Second time period or span FIG. 2-C. is complimented by reverse spin torque applied to gyros 1 & 2 with 0 v, allowing them to “REACH” without generating counter spin torque against gyros 3 & 4 with “No Loss” as 0-volt of inducing voltage for gyro rotation may allow it to lose Spin RPM as balance of energy, as it climbs in a REACH motion.

### Motor Controls

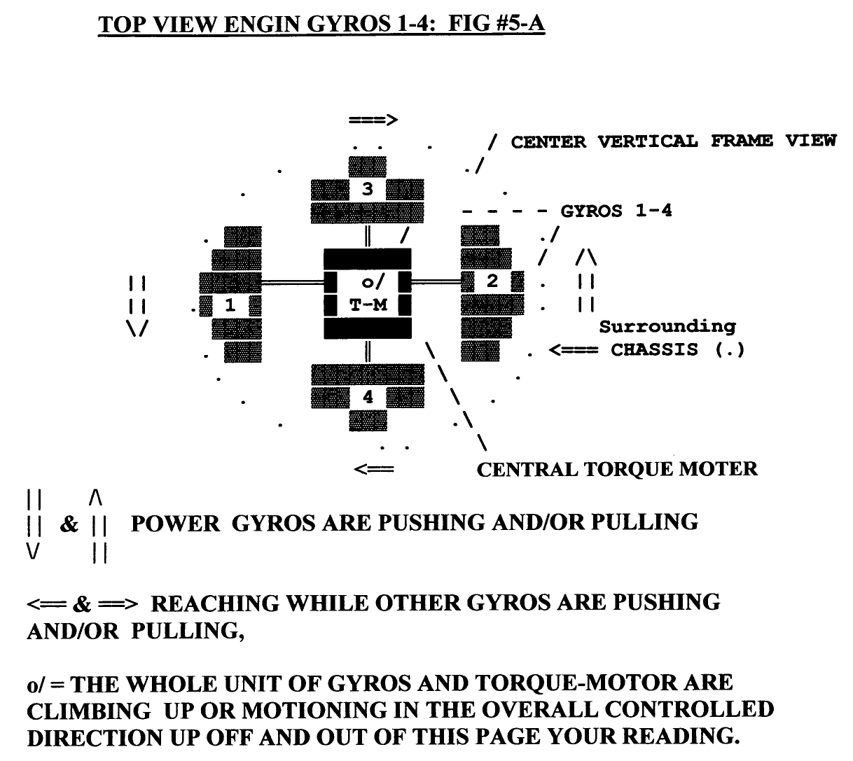

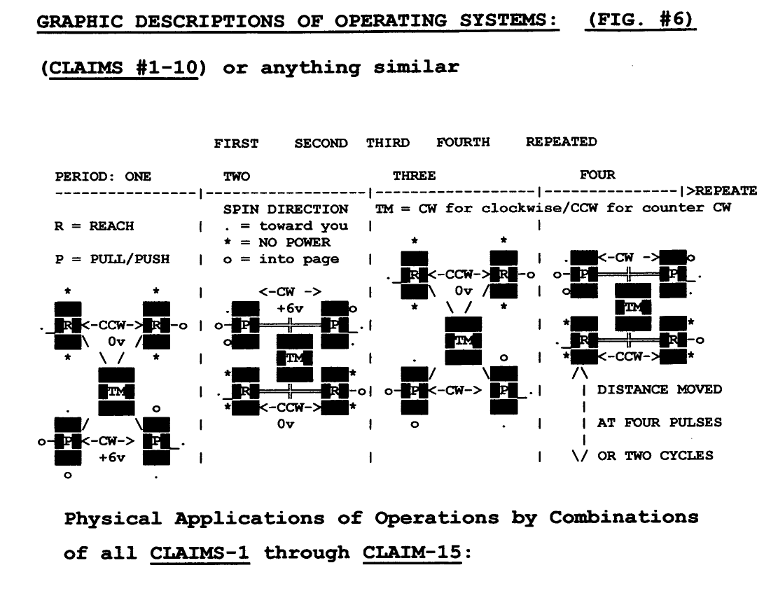

These three “POWER SUPPLY TIMING SQUARE-WAVES” FIGS. 2-A, 2-B and 2-C displayed on same page (11) above to show the relationship of timing differences of power from the TORQUE MOTOR supplied between GYROs 1+2 and GYROs 3+4, as their positive and negative voltage applications referred to in their descriptions, contrasting with “R's” and “P's” while in FIG. 6, while a pair “PUSH or PULL”, the other pair “REACH”.

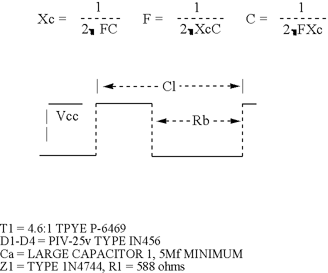

Ra=100K ohms charge time—T1=0.693 (Ra+Rb)C1
Rb=0-1 m ohms discharge time—T2=0.693 (Rb)C1
C1=0.1-1 micro-f Total—T=T1+T2=0.693 (Ra+Rb)C1

Freq=1/T=1.44/(Ra+2Rb)C1

EXAMPLE: Duty cycle=d=Ra+Rb/Ra+2Rb
At 10 cycles/per second,
4 gyros weigh 5 lbs./each with 6″ diameter
torque motor weigh 10 lbs.
force=mass×acceleration
20 lbs/30 lbs×100/cps=⅔ lbs×100/2×6″=16.6675 ft-lbs/sec
work=force×distance, 16.6675 ft-lbs/sec×6 ft=100.005??

### Written Descriptions Operating Systems

### Claims #1-10

At the instant of ending first time period and full contraction occurs by gyros 1 & 2, the second time period begins FIG. 6 reversing the ™ torque motor spin between gyros 1&2 to 3&4. The resulting +6 v applied to gyros 3 & 4 rotating in clockwise directions induces antigravity push down FIG. 6 and FIG. 1-B, while forcing the center torque motor up with the gyros 1 & 2, also, reaching for new space available FIG. 1-B (1&2).

This continues until gyros 1 & 2 reach maximum extension occupying fresh space as gyro 3 & 4 maximize their downward pushing extension as displayed in FIG. 6 and FIG. 1-B,

Next is the start of the third time period, which is a repeat of the first. The torque motor is again reversed polarity for torque motor spin directions while gyros 1 & 2 are supplied +6 v in parallel with clockwise power applied to the torque motor. Gyros 1 & 2 will attempt to maintain their location in new space as the weight of the torque motor and gyros 3 & 4 are lifted in their combined reaching action, with counter torque applied released in 0 volts spin voltage applied to gyros 3&4, which allows loss counter torque in gyro's RPM.

Following is the fourth time period repeating the second as torque motor power is reversed polarity to reverse the spin between gyros 1&2 and 3&4. Again gyro 1&2 power is cut to 0 v as gyros 3&4 power is applied at +6 v to have them maintain their contracted position pushing down or against gravity, forcing the torque motor and gyros 1&2 back up again.

### Warning

Do NOT apply full power to torque motor when gyros are in full spin, without viewed and regulated clearance overhead, for center torque motor controls to twist and start the Gyros to begin REACHING as SkyKraft STARTS climbing up In a VIBRATING TWISTING AND COUNTER TWISTING SEQUENCES!

### Power Applications”

### Claim #11-16

1. Stable condition: power applied to 1-4 gyros to achieve max R.P.M. in directions shown FIG. 1-A and FIG. 1-B.
2. Square wave power replaces gyros' max R.P.M. spin poweras shown supply timing square-wave FIG. 2-A & FIG. 2-C.
3. Monitor applied ocilliscope to gyro and torque waves to view achievment of 180° difference in voltages applied between gyros #1 & #2 against gyros #3 & #4 as shown in (FIG. 2-A,B,C).
4. Synchronize gyros' actions to replicate displayed reach-push, pull-reach actions in FIG. 1-B, by applying difference varing bandwith, frequency, and amplitude voltages to achieve opposite arching for verticle reaching motions as illustrated FIG. 2-B.
   *** Clear Surrounding Area *** apply increased voltage to torgue motor with square wave to induce torgue between gyros as shown in FIG. 2-B by expanding positive cycle of square wave (band-width) and increasing frequency to ascend gain to control lift-off as distance moved as shown in FIG. 6.

1. This engine will internally force itself in any direction it is controlled regardless of the surrounding environment or atmosphere, whether it be gas, liquid or solid.

2. If gyroscopes will maintain a set plane in space, and only alter from that space at a ninety degree angle, with an angular motion in relation to the induced pressure, then any arrangement of that physical formula is possible, and an induced torque applied at a patented secret location in relation to another torque upon or within another gyroscope or related attached mechanism can produce that primary force or pressure in the opposite direction. (See FIG. 6)

3. If this change of location is what a gyro measures, when a Gyroscopic Torque Induced Uni-directional Engine can use electricity to change location, similar to gyros' change of location to produce electricity for mechanical measurements of such. (See FIG. 6)

4. The power applied can be controlled, so controlled directions can be used to maneuver the engine in directions systematically controlled to create it's motion: (FIG. 2a,b,c)

5. If “work is equal to its mass times its distance”, its acceleration times that the distance displacement accomplished through vector angle reinforced torque inductions by the actions of Gyros. This operation can be repeated during the same time span: (FIG. 6)

6. by the second similar arrangement of gyros (3&4) can be inducing torques 180 degrees out of phase with Gyros 1 & 2. (FIG. 2a,b,c) & (See FIG. 6)

7. The Sky Kraft engine Gyros timed to support one another through their counter reactions, can “crawl” through space like a twisting caterpillar. (See FIG. 6)

8. Similar to the four cycle piston engine with: intake, power, compression and exhaust, Gyros acts of can be described as: “Push-Reach, Pull-Reach.” (See FIG. 1a)

9. These three “POWER SUPPLY TIMING SQUARE-WAVES” FIGS. 2-A, 2-B and 2-C May be applied as displayed on that same page to show the relationship of the voltages timing differences from the TORQUE MOTOR supplied between Gyros 1+2 and Gyros 3+4, as their positive and negative voltage applications referred to in their descriptions, contrasting while two Bottom Gyros “PUSH”, the other top two Gyros “REACH”. (FIG. 1a, and FIG. 1b)

10. These three “POWER SUPPLY TIMING SQUARE-WAVES” FIGS. 2-A, 2-B and 2-C May be applied as displayed on that same page to show the relationship of the voltages timing differences from the TORQUE MOTOR supplied between Gyros 3+4 and Gyros 1+2, as their positive and negative voltage applications referred to in their descriptions, contrasting while two TOP Gyros “PULL”, the other Bottom two Gyros “REACH”.

11. the motor control voltages displayed under title “Control Motors” on page 13, are applicable and correct in proportion to all variables applied within or completing the working formulas, as listed in all Figures as applicable “Gyroscopic Motion Induced Elements”.

12. Under stable conditions: power applied to 1-4 Gyros to achieve max R.P.M. in directions shown in FIG. 1-A and FIG. 1-B.

13. the square wave of voltage of power replaces Gyros max R.P.M. spin power as shown in the supplying timing square wave display in FIG. 2-A & FIG. 2-C.

14. A monitor applied oscilloscope to Gyros and Torque Motor to view the square waves to view the achievements of 180° differences in voltages applied between Gyros #1 & #2 against Gyros #3 & #4 AS SHOWN IN (FIG. 2-A,B,C).

15. the synchronize Gyro's actions are to replicate displayed Reach-Push, Pull-Reach actions in FIG. 1-B, by applying difference varying bandwidth, Frequency, and Amplitude Voltages to achieve Opposite Arching for overall “Vertical Reaching Motions as illustrated In FIG. 2-B.

16. Apply increased voltage to torque motor with square wave to induce torque between gyros as shown in FIG. 2-B. by expanding positive cycle of square wave (band-width) and increasing frequency to ascend gain to control lift-off as distance moved as shown in FIG. 6.
